(19) United States
(12) Patent Application Publication
(10) Pub. No.: US 2016/0325531 A1
(43) Pub. Date: Nov. 10, 2016

(54) MULTILAYER STRUCTURE MADE OF POLYCARBONATE AND POLYCARBONATE BLENDS WITH HIGH OPTICAL QUALITY AND HIGH SCRATCH RESISTANCE AND WEATHERING RESISTANCE

(71) Applicant: COVESTRO DEUTSCHLAND AG, Leverkusen (DE)

(72) Inventors: Frauke KÜHN, Leverkusen (DE); Frank BUCKEL, Kempen (DE); Peter CAPELLEN, Krefeld (DE); Alexander MEYER, Düsseldorf (DE)

(21) Appl. No.: 15/105,387

(22) PCT Filed: Dec. 16, 2014
(86) PCT No.: PCT/EP2014/077876

§ 371 Date: Jun. 16, 2016

(30) Foreign Application Priority Data
Dec. 19, 2013 (EP) 13198309.0

(51) Int. Cl. B32B 27/08; B32B 27/40; B32B 27/18; B32B 27/28; B32B 27/30; B32B 27/36; B32B 27/32

(52) U.S. Cl. CPC B32B 27/08; B32B 27/365; B32B 27/36; B32B 27/40; B32B 27/325; B32B 27/283; B32B 27/308; B32B 27/302; B32B 27/18; B32B 2255/10; B32B 2270/00; B32B 2307/412; B32B 2307/41; B32B 2307/584; B32B 2307/712; B32B 2307/71

(57) ABSTRACT

The invention relates to a transparent multilayer structure containing a transparent base layer containing at least one transparent thermoplastic and also other layers according to the invention; the production of this multilayer structure; the use thereof for producing mouldings such as plastics glazing for buildings, motorcycles, automobiles, rail vehicles, aircraft and panels, and for pillar and bodywork covers; and to the mouldings themselves. The multilayer structure is characterized in that it has high scratch resistance and high weathering resistance, and also excellent, long-lasting optical properties.

The invention concerns a multi-layer structure containing a transparent base layer, which includes at least one transparent, thermoplastic polymer, as well as further layers in accordance with the invention, such as at least one non-transparent material, which is partially or wholly moulded on the transparent layer, the manufacture of such a multi-layer structure, its use for manufacturing mouldings, such as polymer glazings for buildings, motorcycles, automobiles, rail vehicles and aircraft, as well as apertures and pillar covers and car body panels, and also the mouldings themselves. The multi-layer structure is characterised in that it is highly scratch-resistant and has a high resistance to weathering, as well as permanently excellent optical properties.

Glazings made of composites, containing transparent thermoplastic polymers, such as polycarbonate, offer many benefits in the automotive sector and in regard to buildings compared to conventional glazings made of glass. The latter include, for example, increased breakage resistance and saving on weight, which, in the case of automotive glazings, enables increased passenger safety in the event of road accidents, as well as lower petrol consumption. Finally, transparent materials containing transparent thermoplastic polymers permit considerably greater freedom of design due to the easier malleability.

Panes in the field of the transport sector frequently also include non-transparent areas. Non-transparent layers are, for example, very frequent with panes in the automotive sector, as, in this sector, functional elements, for instance, may be concealed or, in general, the adhesives for fastening them may be applied to the car bodywork.

While thermoplastic polymers have the beneficial properties described above, for some applications they demonstrate too low an abrasion resistance and resistance to chemical solvents. Furthermore, like many other organic polymeric materials, they are also sensitive to being decomposed by ultra-violet light. This leads to yellowing and erosion of the substrate surface.

For these reasons, thermoplastic substrates, such as polycarbonate parts, are coated with a protective coating. In that context, precisely those systems that constitute both mechanical protection against abrasion and scratching and excellent protection against climatic influences, i.e. rain, temperature, and in particular ultra-violet (UV) radiation, are especially suited for outdoor use.

Such coated polycarbonates are, for example, described in DE 102008010752 A and WO 2009049904 A.

US 2007/0212548 A1 describes a multi-layer structure which differs considerably in the non-transparent layer from the present multi-layer structure. The non-transparent coating is an ink (see lines 5-6 of paragraph [0013]) containing a polyester resin. The layer only has a thickness of greater than 3 μm, preferably 5 to 8 μm. In contrast to the latter, a non-transparent polycarbonate blend is used in the present application, in the form of a considerably thicker layer of between 1 mm and 20 mm.

DE10 2007 050 192 A1 describes a primer composition, in which triazine is utilised as a UV absorber. EP2063685 A1 describes a thermoplastic glazing component, in the case of which at least one wire is embedded in a large proportion of the surface. A multi-layer structure of the present application is not described.

However, the multi-layer structures portrayed in the prior art, with a base layer made of a transparent thermoplastic polymer, as well as at least one non-transparent material, do not possess the long-term stability that is customary with glass and is desired in the architecture and automotive sectors. In that respect, the term “long-term stability” within the meaning of the present invention describes the stability of the properties of the entire multi-layer structure, such as colour, freedom from turbidity, transparency and optical quality of the surface over the period of use, and subject to the influence of the environmental factors typical of the application (such as UV radiation, temperature, dampness, chemical media, abrasion, etc.). Stability does not, in this case, mean absolute constancy, but by all means moderate change within pre-defined limits.

To compound the matter, there is in addition the fact that, for the above-mentioned applications, the requirements posed of the properties are extremely high, so that there is less scope for loss of properties. In automotive construction, ambitious requirements exist in regard to the visual appearance and the visual parameters of the materials installed, especially for high-priced vehicles. Inhomogeneities (surface defects), or optical faults in the component surface, impairments in the component surface, impairments in the sheen and turbidity are not acceptable, in this connection.

Modern glazing systems in the architecture and automotive sectors also, moreover, need to fulfil functional requirements, which serve the purpose of comfort, such as selecting blocking of IR and UV rays, in order to prevent the interior from being heated up too much by IR rays or damaged by UV rays.

In addition, due to the construction of vehicle components becoming ever more complex, efficient manufacturing processes, which make it possible to manufacture the components in as few stages as possible, are currently in increasing demand.

Multi-layer items made of polycarbonate—in particular concerning multi-layer items containing a substrate layer of polycarbonate and at least one scratch-resistant layer made of a varnish containing siloxane—are essentially described in the literature.

Thus, EP 2247446-A1 describes a special, asymmetric multi-layer structure of polycarbonate. However, no multi-layer structure made of transparent and non-transparent layers is described. As such a layer structure behaves noticeably differently in conditions of weathering, EP 2247446 cannot give any guidance on how the task described is to be resolved.

U.S. Pat. No. 7,442,430 describes multi-layer structures made of polycarbonate and polymethyl methacrylate which have a high degree of stability against weathering. Also in this case, however, no multi-layer item with non-transparent layers is mentioned. Thus, this application also does not provide any indication of how the problem described is to be solved.

WO 2011/032915 also describes a special multi-layer structure. This structure is not the subject of the present invention.

EP 1624012-A describes a flat-shaped window element with frame element made of various thermoplastics, as well as rubbers. No statement is made on the UV resistance. This application also does not give any indication of how to resolve the task.

It is the task of the present invention to provide a multi-layer structure containing at least one transparent layer and at least one non-transparent layer, which, in particular in the non-transparent area, possess an increased degree of resistance against weathering. Thus, a greater lifespan of the top layers lying on top of the substrate layers is, for example, meant. In addition, the multi-layer structure should have a high degree of scratch resistance and abrasion resistance. The multi-layer structure should, moreover, have optical properties that are permanently excellent, specifically a reduced loss of light transmission, a reduced increase in turbidity, a low tendency to change the colour in the transparent area, and a crack-free and erosion-free surface, always after weathering or the effect of media. In addition, the individual layers of the multi-layer structure should possess a very good adhesion to one another.

Solar radiation leads to the multi-layer structure being heated. This in particular has an impact upon the weathering stability of the entire structure in the non-transparent area (e.g. in a dark or black layer). This is expressed in the formation of cracks, micro-cracks and/or delamination of the outer layer. No indication is contained in US 2007/0212548 A1 concerning how the problems can be resolved with a thicker, non-transparent layer.

Furthermore, the compound of Layers B and C of the present invention can be produced in a simple way in a two-component injection moulding process. In US 2007/0212548 A1 the compound of B and C is produced in two different processing technologies (lines 8-18 of paragraph [0030]), wherein the ink needs to be dried and burned in ([0032]).

This poses a particular challenge in the case of components that are formed with a non-transparent layer. The dark colour leads to a noticeably more rapid ageing in the weathering. This is brought to light by Examples 5 and 6.

It is, moreover, a task of the present invention to provide a method of manufacturing the multi-layer structure in accordance with the invention.

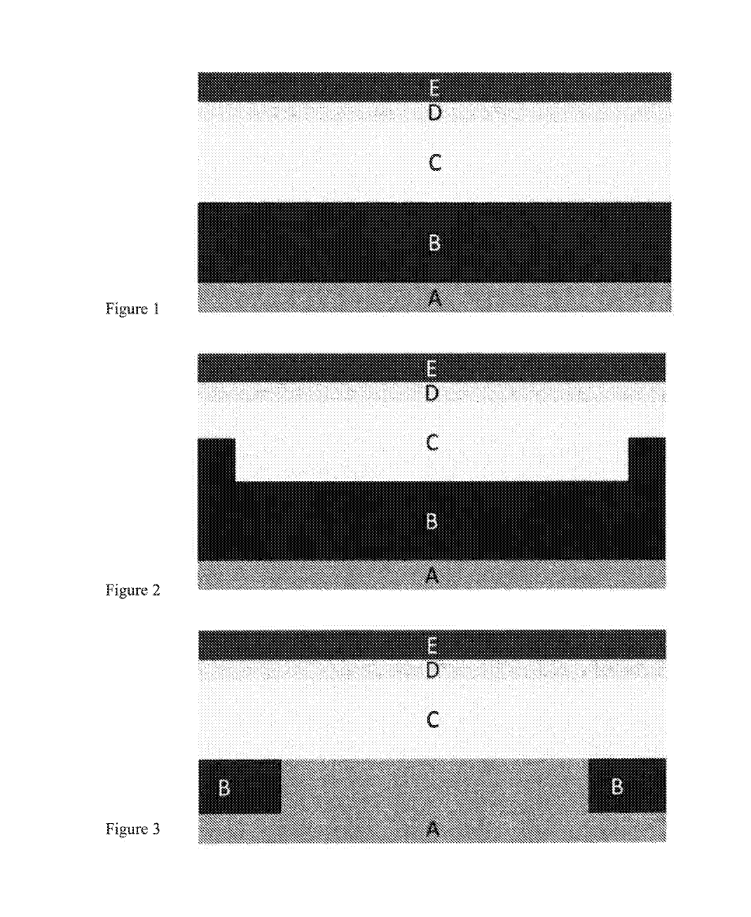

The task posed could, surprisingly, be resolved by the multi-layer structure in accordance with the invention containing the layers A (3 μm-20 μm, preferably 5 m-15 μm, and especially preferably 6 μm-12 μm, transparent wear-resistant layer), B (1 mm-20 mm, preferably 1 mm-18 mm, non-transparent layer), C (1 mm-20 mm, preferably 1 mm-18 mm, transparent base layer), D (1 μm-6 μm, preferably 1.2 μm-5 μm, especially preferably 1.2-4 μm, transparent UV protection layer) and E (3 μm-25 μm, preferably 4 μm-15 μm transparent wear-resistant layer), adhering to layer thickness ranges in accordance with the invention. Layer A is in this respect located on the side of each interior (e.g. automotive or building interior) and layer E on the side of the respective external environment with their corresponding weathering conditions. Thus, viewed from the inside out, the layer sequence A, B, C, D, E in FIG. 1 shows schematic drawings of possible layer structures. Layer A is, in this respect, on the inside, and layer E is the outside.

Alternatively, the layer E may exclusively consist of a silica layer with a layer thickness in the range from 1 μm to 5 μm, preferably 2 μm to 4 μm, made via plasma deposition or various sputtering methods such as HF sputtering, magnetron sputtering, ion beam sputtering, etc., ion plating by means of the DC, RF, HCD methods, reactive ion plating, etc., or chemical vapour deposition.

The subject of the present invention is therefore a multi-layer structure containing the following layers:

Layer A (a transparent wear-resistant layer) with a layer thickness of 3 μm-20 μm, preferably 5 μm-15 μm, and especially preferably 6 μm to 12 μm,
Layer B (a non-transparent layer) with a layer thickness of 1 mm to 20 mm, preferably 1 mm to 18 mm;
Layer C (a transparent base layer) with a layer thickness of 1 mm to 20 mm, preferably 1 mm to 18 mm;
Layer D (a transparent UV protection layer) with a layer thickness of 1 μm to 6 μm, preferably 1.2 μm-to 5 μm, especially preferably 1.2 μm to 4 μm,
Layer E (a transparent wear-resistant layer) with a layer thickness of 3 μm to 25 μm, preferably 5 μm-4 μm,

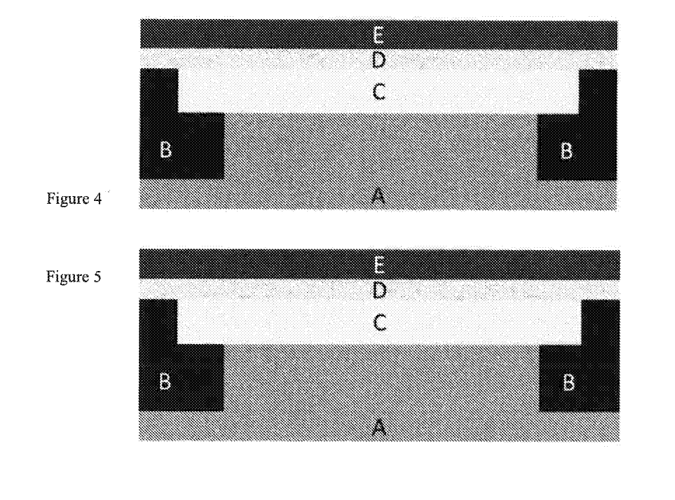

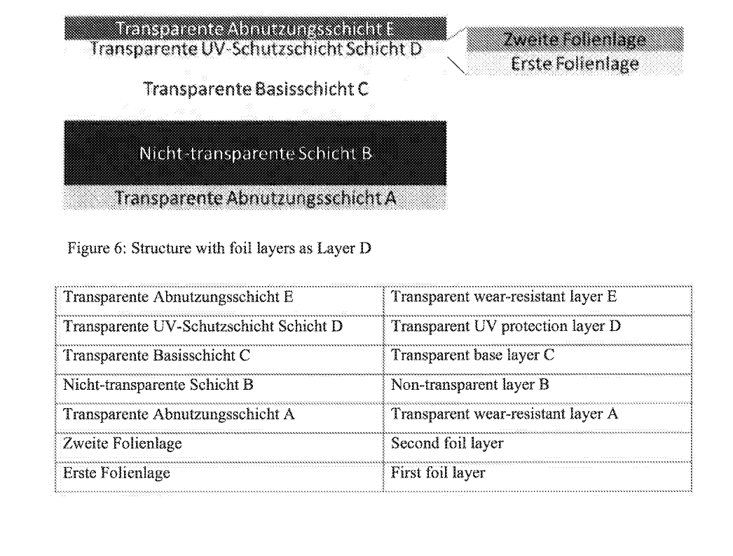

In FIGS. 1 to 6 schematic drawings of potential layer structures are shown. Layer E is the outer layer and Layer A the internal layer in these figures.

Preferred in the above-mentioned multi-layer structure are Layer E outside and Layer A inside.

### Transparent Wear-Resistant Layer A:

In regard to the wear-resistant layer A, in principle the following coating systems come into question:

(i) Thermosetting layer systems based on a polysiloxane, which, if necessary, may be provided with an adhesion-promoting primer layer only between the substrate (Layer B and/or Layer C) and polysiloxane coating varnish. These are described, for example, in U.S. Pat. No. 4,278,804, U.S. Pat. No. 4,373,061, U.S. Pat. No. 4,410,594, U.S. Pat. No. 5,041,313 and EP-A-1087001.

A polysiloxane varnish contains organosilicon compounds of the formula RₙSiX₄₋ₙ (where n may range from 1 to 4) where

R stands for C₁ to C₁₀ aliphatic radicals, preferably methyl, ethyl, propyl, isopropyl, butyl, and isobutyl, and aryl radicals, preferably phenyl, and substituted aryl radicals and
X stands for H, C₁ to C₁₀ aliphatic radicals, preferably methyl, ethyl, propyl, isopropyl, butyl, and isobutyl, and aryl radicals, preferably phenyl, substituted aryl radicals, OH, Cl or partial condensates thereof.

The polysiloxane varnish will be fabricated using the sol-gel process. The sol-gel process is a process for the synthesis of non-metallic inorganic or hybrid polymeric materials of colloidal dispersions, so-called sols.

The term “merely adhesion-promoting primer layers” refers to those primer layers, which consist of an adhesion-promoting polymer and optionally one or more UV absorbers.

If Layer A consists of a single layer system, a siloxane grid with a coupling agent based on acrylate is preferred for its fabrication, wherein the layer A contains a UV absorber in amounts of 5-15 wt %, preferably 8-13 wt %. In this respect, the use of UV absorbers from the class of benzophenones and resorcinols is preferred.

For the benzophenones, in this respect compounds of the structure (I) are preferably used.

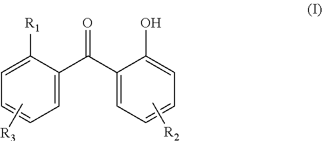

This involves R1, R2 and R3=H, C1-C8-alkoxy, carboxy, halogen, hydroxy, amino or carboethoxy. For the resorcinols, compounds of the structure (II) are preferably used.

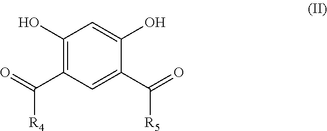

This involves R4 and R5=independently substituted monocyclic or polycyclic aryls.

Examples of commercially available systems for the construction of Layer A include, for example, the products PHC 587, PHC 587 B and PHC 587 C by Momentive Performance Materials Inc., Wilton, Conn., USA and KASI Flex® or Sun Flex®, both by KRD Coatings, Geesthacht, Germany, or Silvue® MP 100, SDC Coatings, Germany, or SICRALAN® MRL by GFO, Schwaebisch Gmuend, Germany.

When using the above-mentioned siloxane systems, layer thicknesses of 3 μm-20 μm, preferably 5 μm-15 μm and particularly preferably 6 μm to 12 μm are preferred for Layer A.

The figures for the layer thicknesses include the above-mentioned upper and lower limits in each case. This applies to all layer thickness ranges mentioned in the context of the present invention.

(ii) Thermosetting multilayer systems with a UV protection primer and a topcoat based on a polysiloxane varnish. Suitable systems are known, for example, from U.S. Pat. No. 5,391,795 and U.S. Pat. No. 5,679,820 and “Paint & Coating Industry; July 2001 pp. 64 to 76: The Next Generation in Weatherable Hardcoats for Polycarbonate” by George Medford/General Electric Silicones, LLC, Waterford, N.Y.; James Pickett/The General Electric Co., Corporate Research and Development, Schenectady, N.Y.; and Curt Reynolds/Lexamar Corp., Boyne City, Mich. Suitable systems moreover include those described in PCT/EP2008/008835.

By way of example, the following system is mentioned here as a primer system, including:

a) 100,000 parts by weight of a binder,
b) 0 to 900,000 parts by weight of one or more solvents;
c) 1 to 6,000, preferably 2,000 to 5,000, parts by weight of a formula (III) compound;
d) 0 to 5,000 parts by weight of further light-stabilising substances

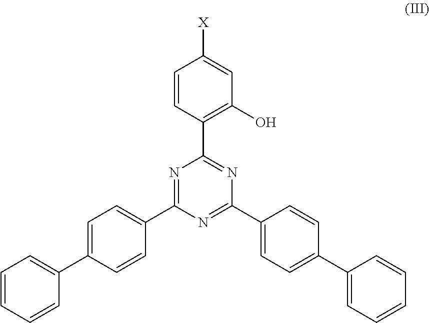

wherein X=OR⁶, OCH₂CH₂OR⁶, OCH₂CH(OH)CH₂OR⁶ or OCH(R)COOR⁸, where
R⁶=branched or unbranched C₁-C₁₃-alkyl, C₂-C₂₀o-alkenyl, C₆-C₁₂ aryl, or CO—C₁-C₁₈ alkyl,
R⁷=H or branched or unbranched C₁-C₈ alkyl, and
R⁸=C₁-C₁₂-alkyl; C₂-C₁₂-alkenyl or C₅-C₆ cycloalkyl.

Both layers, i.e. primer and top coat, in this respect take on the task of ensuring UV protection.

A commercially available system involves the combination of SHP470FT2050 (UV-protective primer)/AS4700 (top coat) system from Momentive Performance Materials.

If Layer A consists of a multilayer system with a UV-protective primer and a top coat, the primer is preferably based on a poly (alkyl) acrylate, particularly preferably PMMA and contains at least one UV absorber, preferably selected from the group consisting of resorcinols, benzophenones, and triazines. Particularly preferred triazines are, within the scope of the present invention, 2-[2-hydroxy-4-(2-ethylhexyl)oxy]phenyl-4,6-di(4-phenyl)phenyl-1,3,5-triazine (CAS No. 204583-39-1) and 2-[2-hydroxy-4-[(octyloxycarbonyl)ethylidenoxy]phenyl-4,6-di(4-phenyl)phenyl-1,3,5-triazine (CAS No. 204848-45-3). Particularly preferred benzophenones include, within the scope of the present invention, 2,4-dihydroxybenzophenone, as well as generally 2-hydroxy-4-alkoxybenzophenones. Particularly preferred resorcinols generally include, within the scope of the present invention, 4,6-dibenzoylresorcinols.

The thickness of the primer layer is in the range of 1.0 to 6.0 μm, preferably 1.2 to 5 μm, particularly preferably 1.2 to 4 μm. Primers of such a kind are commercially available, inter alia, in the form of the SHP 470 FT 2050 Silicone Hardcoat Primer. (Momentive Performance Materials Deutschland GmbH, Leverkusen, Germany).

The cover layer is preferably formed by a siloxane grid, which can be obtained by thermally curing the polysiloxane varnish described above, which contains 5-12 wt % preferably 7-10 wt % (in relation to the composition of the outer layer) of a UV absorber. As UV absorbers resorcinols, benzophenones or triazines are preferred, especially silylated resorcinols, benzophenones and triazines, more preferably resorcinols of the structure (IV).

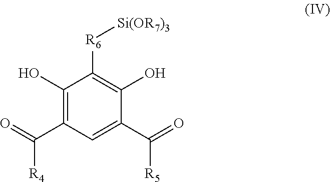

where R₄ and R₅ are, independently of one another, a substituted or unsubstituted monocyclic or polycyclic aromatic radical, and R₆ is a carbon or a linear or branched aliphatic chain consisting of less than 10 carbon atoms and R₇ is a C₁-C₄ alkyl group.

Very particularly preferred is the use of 4,6-dibenzoyl-2-(3-triethoxysilylpropyl) resorcinol (based on the above-mentioned formula where R₄=R₅=phenyl; R₆=C₃-chain and R₇=ethyl) (see Formula (V))

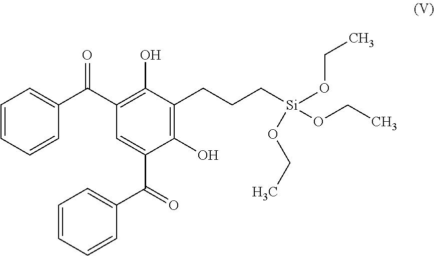 [SMILES: CCO[Si](CCCc1c(O)c(C(=O)c2ccccc2)cc(C(=O)c2ccccc2)c1O)(OCC)OCC]

The thickness of the cover layer is in the range of 2 μm-14 μm, in the see-through area for the most part in the range of 3 μm to 8 μm. An example of a commercially available siloxane grid for the cover layer is the product AS 4700 (Momentive Performance Materials Deutschland GmbH, Leverkusen, Germany).

If necessary, other additives may be added, for example hydrophilising substances in all varnish systems.

The total layer thickness of the wear layer A is 3 μm to 20 μm, preferably 5 μm to 15 μm and particularly preferably 6 μm to 12 μm. In addition, Layer A and Layer E meet the practical requirements for abrasion resistance and resistance to exposure to chemical media as occurring when cleaning the pane.

Abrasion resistance is deemed sufficient if the increase in turbidity is less than 4% after 100 cycles of the Taber test (conducted in accordance with UN ECE Regulation 43, Annex 3, paragraph 4) for the inner layer A or the increase in turbidity is less than 10% after 500 cycles for the outer layer E.

The chemical resistance to gasoline or reference kerosene under load in accordance with UN ECE Regulation 43, Appendix 3, paragraph 11 must be given.

### Non-Transparent Layer B

The non-transparent base layer consists of a polymer blend, preferably of a polycarbonate blend, wherein the polycarbonate is the main component. Extensive areas of the non-transparent Layer B are in direct contact with the transparent base layer C. In particular embodiments, this non-transparent material may wholly or partially surround or frame the base layer C, or, alternatively, the base layer C and further layers directly or indirectly bonded to it, or alternatively the entire multi-layer structure, in the peripheral areas. When the non-transparent material is moulded, the materials adjoin one another preferably in the peripheral regions, so that any unevenness occurring is eliminated. In any case, there are areas in which the base layer C is arranged on top of the non-transparent layer B.

These non-transparent materials can be used for forming black edges or reinforcing frame elements. For creating black edges or reinforcing frame elements the use of thermoplastic resins containing fillers or reinforcing materials, in particular the use of plastic blends fitted in this way is advisable. In this context, blends containing polycarbonate and at least one further thermoplastic material are preferred.

The fillers and reinforcing materials used may be fibrous, lamellar, tubular, rod-shaped, spherical or of a particular shape. Fillers and reinforcing materials suitable for the purposes of the present invention include, for example, talc, wollastonite, mica, kaolin, diatomaceous earth, calcium sulphate, calcium carbonate, barium sulphate, glass fibres, glass or ceramic beads, hollow glass spheres or ceramic hollow spheres, glass or mineral wool fibres, carbon fibres or carbon nanotubes. Preferred fillers are fillers which result in an isotropic shrinkage behaviour of the composition.

Within the scope of the present invention, the use of talc and short-glass fibres is particularly preferred.

Glass or ceramic spheres or hollow spheres can be used to improve scratch resistance of such surface.

In the compositions, the content of fillers and reinforcing materials is 5 wt % to 40 wt %, preferably 7 wt % to 30 wt %, more preferably from 8 wt % to 25 wt %, wherein the weight details relate to the total composition of (B).

Further, the material used for the production of non-transparent material can, optionally, contain the conventional polymer additives described in EP-A 0839623, WO-A 96/15102, EP-A 0500496 or in the “Plastics Additives Handbook”, Hans Zweifel, 5th Edition 2000, Hanser Verlag publishers, Munich.

These include organic and/or inorganic colouring agents or pigments, UV absorbers, IR absorbers, mould release agents, heat stabilisers or processing stabilisers.

Said polymer blend is preferably a blend comprising at least one polycarbonate and at least one polyester, wherein the polyester is preferably a polyalkylene terephthalate, more preferably a polyethylene terephthalate (PET) or a polybutylene terephthalate (PBT). For the polyester, PET is particularly preferred.

The proportion of polycarbonate in the polycarbonate polyester blends amounts to 10 wt % to 90 wt %, preferably wt % to 80 wt %, more preferably 35 wt % to 70 wt %, more preferably 40 wt % to 65 wt %, in each case given in relation to the total composition of non-transparent material.

The proportion of the polyester in the polycarbonate polyester blends is 60 wt % to 5 wt %, preferably 50 wt % to 10 wt %, more preferably 35 wt % to 10 wt %, more preferably 25 wt % to 15 wt %, in each case given in relation to the total composition of non-transparent material.

Optionally, the compositions of the polycarbonate blends of Layer B may also contain elastomer modifiers in amounts ranging from 0 wt % to 25 wt %, preferably from 3 wt % to 20 wt %, more preferably 6 wt % to 20 wt % and particularly preferably 8 wt % to 18 wt %. Again, the wt % figures relate to the total composition of non-transparent material.

In an alternative special embodiment of the present invention, the polymer blend is a composition containing the polymers a1 to a3, wherein

a1 is 10 to 100 parts by weight, preferably 60 to 95 parts by weight, particularly preferably 75 to 95 parts by weight, in particular 85 to 95 parts by weight (based on the sum of components A) and B)) of at least one component selected from the group consisting of aromatic polycarbonate, aromatic polyester carbonate, polymethyl methacrylate (co) polymer and polystyrene (co) polymer, and
a2 is 0 to 90 parts by weight, preferably 5 to 40 parts by weight, especially preferably 5 to 25 parts by weight, in particular 5 to 15 parts by weight (in relation to the sum of the components A) and B)) of at least one graft polymer. The graft polymer is preferably prepared using the emulsion suspension method, bulk polymerization, or the solvent method.
a3 is optionally rubber-free vinylhomopolymerisate and/or rubber-free vinylcopolypolymerisate,
wherein the parts by weight of the components a1 to a3 to when added up together make 100.

The component a2 preferably comprises one or more graft polymers of

F.1.1 5 to 95, preferably 30 to 90 wt % of at least one vinyl monomer on
F.1.2 95 to 5, preferably 70 to 10 wt % of one or more graft bases.

The glass transition temperatures of the graft bases are preferably <10° C., preferably <0° C., particularly preferably <−20° C.

The graft F.1.2 generally has an average particle size μm (d₅₀ value) of 0.05 to 10 μm, preferably 0.1 to 5 μm, particularly preferably 0.15 to 1 μm.

Monomers F.1.1 are preferably mixtures of

F.1.1.1 50 to 99 parts by weight of vinylaromatics and/or vinylaromatics substituted on the nucleus (such as styrene, α-methylstyrene, p-methylstyrene, p-chlorostyrene) and/or methacrylic acid (C₁-C₈) alkyl esters, such as methyl methacrylate, ethyl methacrylate), and
F.1.1.2 1 to 50 parts by weight of vinyl cyanides (unsaturated nitrites such as acrylonitrile and methacrylonitrile) and/or (meth) acrylic acid (C₁-C₈)-alkyl esters such as methyl methacrylate, n-butyl acrylate, t-butyl acrylate, and/or derivatives (such as anhydrides and imides) of unsaturated carboxylic acids, for example maleic anhydride and N-phenyl maleimide.

Preferred monomers F.1.1.1 are selected from at least one of the monomers styrene, α-methyl styrene and methyl methacrylate, preferred monomers F.1.1.2 are selected from at least one of the monomers acrylonitrile, maleic anhydride and methyl methacrylate. Particularly preferred monomers are F.1.1.1 styrene and F. 1.1.2 acrylonitrile.

Suitable graft bases F.1.2 for the graft polymers F.1 are, for example, diene rubbers, EP(D)M rubbers, i.e. those based on ethylene/propylene and optionally diene, acrylate, polyurethane, silicone, chloroprene and ethylene/vinyl acetate rubbers and silicone/acrylate composite rubbers.

Preferred graft bases F.1.2 are diene rubbers, for example based on butadiene and isoprene, or mixtures of diene rubbers or copolymers of diene rubbers or mixtures thereof with further copolymerisable monomers (e.g. according to F.1.1.1 and F.1.1.2), with the proviso that the glass transition temperature of component B.2 is below <10° C., preferably <0° C., particularly preferably <−20° C. Particularly preferred is pure polybutadiene rubber.

Particularly preferred polymers F.1 are, for example, ABS polymers (emulsion, bulk and suspension ABS), as described, for instance, in DE-OS2 035 390 (=U.S. Pat. No. 3,644,574) or in DE-OS 2 248242 (=GB Patent No. 1,409,275) or in Ullmanns, Encyclopedia of Industrial Chemistry, Vol. 19 (1980), pp. 280 et seqq. The gel content of graft base F.1.2 is at least 30 wt %, preferably at least 40 wt % (measured in toluene).

The glass transition temperatures are determined by means of differential scanning calorimetry (DSC) in accordance with standard DIN EN 61006 at a heating rate of 10 K/min., with T_{g} being defined as a midpoint temperature (tangent method).

Preferred is a1) polycarbonate; and a2) acrylonitrile butadiene styrene (ABS).

To avoid component stresses, it is to be ensured that the thermal expansion coefficients of the individual layers are matched with one another by an appropriate choice of materials.

This is particularly important when a black border or frame element is directly applied to the support of the vehicle component in accordance with the invention.

It has proven to be advantageous, in this respect, to select a material for the black border or the frame element whose linear thermal expansion coefficient in the longitudinal direction (i.e. from the gate, looking in the direction of the melt flow, hereinafter referred to as “RS”) is lower than that of the material of the support. In addition, the RS/QS ratio of the linear thermal expansion coefficient of each material should be in a relatively narrow range, wherein the QS transverse direction, i.e. the direction orthogonal to the direction of the melt flow viewed from the gate, is meant.

In one embodiment of the present invention, the linear thermal expansion coefficient of the frame material is lower than that of the support material, in a longitudinal direction, by 1×10⁻⁵ to 3×10⁻⁵ (mm/mm K).

The RS/RQ quotient should be in a range of 0.6 to 1.0.

The material for forming the black border or the reinforcing frame element is preferably bonded to the latter by means of injection back-moulding, particular preferably partial injection back-moulding, in a layer thickness of 1 to 20, preferably 1 to 18 mm of the multi-layer structure.

### Base Layer C:

The base layer C contains at least one transparent thermoplastic polymer, and may be perfectly level, curved differently in different directions or moulded three-dimensionally in the form of bulges, waves or other forms. In this respect, the base layer may, moreover, additionally be further structured and/or moulded.

Transparent within the meaning of the present invention means that the plastic has a light transmission (in compliance with ASTM 1003 and/or ISO 13468; specified in % and illuminant D65/10°) of at least 6%, more preferably of at least 12%, and particularly preferably of at least 23%. Furthermore, the turbidity is preferably less than 3%, more preferably less than 2.5%, and particularly preferably less than 2.0%.

Thermoplastic materials for the base layer C of the multi-layer structure in accordance with the invention are polycarbonate, copolycarbonate, polyester carbonate, polystyrene, styrene copolymers, aromatic polyesters such as polyethylene terephthalate (PET), PET-cyclohexane dimethanol copolymer (PETG), polyethylene naphthalate (PEN), polybutylene terephthalate (PBT), polyamide cyclic polyolefin, poly- or copolyacrylates and poly- or copolymethacrylate, such as poly- or copolymethylmethacrylates (such as PMMA), as well as copolymers with styrene, such as transparent polystyrene-acrylonitrile (PSAN), thermoplastic polyurethanes, polymers based on cyclic olefins (e.g. TOPAS®, a commercial product of the company Ticona), more preferably polycarbonate, copolycarbonate, polyester carbonate, aromatic polyester or polymethyl methacrylate, or mixtures of said components, and particularly preferably polycarbonate and copolycarbonate.

Also, mixtures of several thermoplastic polymers, in particular if they are transparent miscible with one another, are possible, wherein, in a specific embodiment, a mixture of polycarbonate and PMMA (more preferably with PMMA <2 wt %) or polyester is preferred.

A further specific embodiment includes, in this connection, a mixture of polycarbonate and PMMA having <2.0 wt %, preferably <1.0 wt %, more preferably <0.5 wt %, wherein at least 0.01 wt % PMMA is included, in relation to the quantity of polycarbonate, wherein the PMMA preferably has a molecular weight of <40,000 g/mol. In a particularly preferred embodiment, the proportion of PMMA is 0.2 wt %, and particularly preferably 0.1 wt %, in related to the quantity of polycarbonate, wherein the PMMA preferably has a molecular weight of <40,000 g/mol.

An alternative more specific embodiment includes a mixture of PMMA and polycarbonate having less than 2 wt %, preferably less than 1 wt %, more preferably less than 0.5 wt %, wherein at least 0.01 wt % polycarbonate is included, in relation to the quantity of PMMA.

In a particularly preferred embodiment, the amount of polycarbonate is 0.2 wt %, and particularly preferably 0.1 wt %, in relation to the quantity of PMMA.

Polycarbonates suitable for the preparation of the plastic composition of the present invention are all known polycarbonates. These are homopolycarbonates, copolycarbonates and thermoplastic polyester carbonates.

The polycarbonates are preferably prepared using the phase boundary method or the melt transesterification process, which are described variously in the literature.

For the phase boundary method, reference is made, by way of example, to H. Schnell, “Chemistry and Physics of Polycarbonates”, Polymer Reviews, Vol. 9, Interscience Publishers, New York 1964 p 33 et seqq., Polymer Reviews, Vol. 10, “Condensation Polymers by Interfacial and Solution Methods”, Paul W. Morgan, Interscience Publishers, New York 1965, Chap. VIII, p. 325, Drs. U. Grigo, K. Kircher and P. R- Muller, “Polycarbonates” in Becker/Braun, Kunststoff-Handbuch [“Plastics Handbook” ], Vol 3/1, Polycarbonates, Polyacetals, Polyesters, Cellulose esters, pub. Carl Hanser Verlag Munich, Vienna 1992, pp. 118-145 and EP 0 517 044 A1.

The melt transesterification process is, for example, described in the Encyclopedia of Polymer Science, Vol. 10 (1969), Chemistry and Physics of Polycarbonates, Polymer Reviews, H. Schnell, Vol. 9, John Wiley and Sons, Inc. (1964), and also in the patent specifications DE-B 10 31 512 and U.S. Pat. No. 6,228,973.

The polycarbonates are preferably shown by reactions of bisphenol compounds with carbonic acid compounds, in particular phosgene or, in the melt transesterification process, diphenyl carbonate or dimethyl carbonated.

In this respect, homopolycarbonates based on bisphenol A and copolycarbonates based on the monomers bisphenol A and 1.1-bis-(4-hydroxyphenyl)-3,3,5-trimethylcyclohexane are particularly preferred.

These and other bisphenol and/or diol compounds, which can be used for the synthesis of polycarbonates are, inter alia, disclosed in WO 2008037364 A1 (line 21 on p. 7 to line 5 on p. 10), EP 1 582 549 A1 ([paragraphs 0018] to [0034]), WO 2002026862 A1 (line 20 on p. 2 to line 14 on p. 5), WO 2005113639 A1 (line 1 on p. 2 to line 20 on p. 7).

The polycarbonates may be linear or branched. Mixtures of branched and unbranched polycarbonates can also be utilised.

Suitable branching agents for polycarbonates are known from the literature and described, for example, in the patent specifications U.S. Pat. No. 4,185,009 and DE 25 00 092 A1 (in accordance with the invention, 3,3-bis-(4-hydroxyaryl-oxindoles, s. the respective entire document), DE 42 40 313 A1 (see lines 33 to 55 on p. 3), DE 19 943 642 A1 (see lines 25 to 34 on p. 5) and U.S. Pat. No. 5,367,044, as well as and literature cited herein.

Furthermore, the polycarbonates used may also be branched intrinsically, in which case no branching agent is added within the scope of the polycarbonate production. An example of intrinsic branches is so-called “Fries structures”, as disclosed for melt polycarbonates in EP 1 506 249 A1.

In addition, chain terminators may be used in the polycarbonate production. Phenols, such as phenol, alkylphenols, such as cresolm and 4-tert,-butyl phenol, chlorophenol, bromophenol, cumylphenol or mixtures thereof are preferably used as chain terminators.

The thermoplastic polymers of the base layer C may also contain:

### a) Release Agents

Release agents particularly suited to the multi-layer structure in accordance with the invention are pentaerythrityl tetrastearate (PETS) or glycerol monostearate (GMS).

Preference is given to the use of 0.0 wt % to 1.0 wt %, more preferably 0.01 wt % to 0.50 wt %, particularly preferably 0.01 wt % to 0.40 wt % of one or more mould release agents, in relation to the total quantity of mould release agents.

### b) Thermostabilisers/Antioxidants

In a preferred embodiment, the polymer composition of the base layer C contains thermostabilisers or processing stabilisers. Particularly suitable are phosphites and phosphonites, as well as phosphines. Examples are triphenyl phosphite, diphenyl alkylphosphite, phenyl dialkylphosphite, tris(nonylphenyl)phosphite, trilauryl phosphite, trioctadecyl phosphite, distearyl pentaerythritol diphosphite, tris(2,4-di-tert-butylphenyl)phosphite, diisodecyl pentaerythritol diphosphite, bis(2,4-di-tert-butylphenyl) pentaerythritol diphosphite, bis(2,4-di-cumylphenyl) pentaerythritol diphosphite, bis(2,6-di-tert-butyl-4-methylphenyl) pentaerythritol diphosphite, diisodecyl oxypentaerythritol diphosphite, bis(2,4-di-tert-butyl-6-methylphenyl) pentaerythritol diphosphite, bis(2,4,6-tris(tert-butylphenyl) pentaerythritol diphosphite, tristearylsorbitol triphosphite, tetrakis(2,4-di-tert-butylphenyl)-4,4′-biphenylene diphosphonite, 6-isooctyloxy-2,4, 8, 10-tetra-tert-butyl-12H-dibenz[d, g]-1,3,2-dioxaphosphocine, bis(2,4-di-tert-butyl-6-methylphenyl) methylphosphite, bis(2,4-di-tert-butyl-6-methylphenyl) ethylphosphite, 6-fluoro-2,4,8,10-tetra-tert-butyl-12-methyl-dibenz[d, g]-1,3,2-dioxaphosphocine, 2,2′,2″-nitrilo-[triethyltris (3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl) phosphite, 5-butyl-5-ethyl-2-(2,4,6-tri-tert-butylphenoxy)-1,3,2-dioxaphosphirane, bis(2,6-di-ter-butyl-4-methylphenyl) pentaerythritol diphosphite, triphenyl phosphine (TPP), trialkylphenylphosphine, bisdiphenylphosphino-ethane or trinaphthylphosphine. Particularly preferably, triphenyl phosphine (TPP), Irgafos® 168 (tris-(2,4-di-tert-butyl-phenyl)-phosphite) and tris(nonylphenyl) phosphite or mixtures thereof are used.

Furthermore, phenolic antioxidants, such as alkylated monophenols, alkylated thioalkylphenols, hydroquinones and alkylated hydroquinones can be used. Particularly preferably, Irganox® 1010 (pentaerythritol 3-(4-hydroxy-3,5-di-tert-butylphenyl) propionate; CAS: 6683-19-8) and Irganox 1076@(2,6-di-tert-butyl-4-(octadecanoxycarbonylethyl) phenol) are utilised.

In a specific embodiment of the present invention, the phosphine compounds in accordance with the invention are utilised together with a phosphite or a phenolic antioxidant or a mixture of the latter two compounds.

0.00 wt % to 0.20 wt % of one or more thermostabilisers or processing stabilisers, based on the total amount of thermal—or processing stabilisers are utilised, preferably 0.01 wt % to 0.10 wt %, in relation to the total quantity of thermostabilisers or processing stabilisers.

### c) UV Absorbers

In a preferred embodiment, the base layer C furthermore includes an ultra-violet absorber. Ultraviolet absorbers suitable for use in the polymer composition in accordance with the invention are compounds which have as low a transmission as possible, below 400 nm, and as high a transmission as possible, above 400 nm. Such compounds and their preparation are known from the literature, and are, for example, described in EP-A 0 839 623, WO-A 96/15102 and EP-A 0 500 496. Ultraviolet absorbers, particularly suitable for use in the composition in accordance with the invention, are benzotriazoles, triazines, benzophenones and/or arylated cyanoacrylates.

Particularly useful ultraviolet absorbers are hydroxy-benzotriazoles, such as 2-(3′,5′-bis-(1,1-dimethylbenzyl)-2′-hydroxyphenyl)-benzotriazole (Tinuvin® 234, Ciba Specialty Chemicals, Basle), 2-(2′-hydroxy-5′-tert-octyl) phenyl)-benzotriazole (Tinuvin® 329, Ciba Specialty Chemicals, Basle), 2-(2′-hydroxy-3′-(2-butyl)-5′-(tert-butyl) phenyl) benzotriazole (Tinuvin® 350, Ciba Specialty Chemicals, Basle), bis-(3-(2H-benzotriazolyl)-2-hydroxy-5-tert-octyl) methane, (Tinuvin® 360, Ciba Specialty Chemicals, Basle), (2-(4,6-diphenyl-1,3,5-triazine-2-yl)-5-(hexyloxy) phenol (Tinuvin® 1577, Ciba Specialty Chemicals, Basle) and the benzophenone 2,4-dihydroxy benzophenone (Chimasorb® 22, Ciba Specialty Chemicals, Basle) and 2-hydroxy-4-(octyloxy)-benzophenone (Chimassorb® 81, Ciba, Basle), 2-propenoic acid, 2-cyano-3,3-diphenyl-, 2,2-bis [[(2-cyano-1-oxo-3,3-diphenyl-2-propenyl)oxy]-methyl]-1,3-propanediyl ester (9CI) (Uvinul® 3030, BASF AG, Ludwigshafen), 2-[2-hydroxy-4-(2-ethylhexyl) oxy]phenyl-4,6-di(4-phenyl) phenyl-1,3,5-triazines (CGX UVA 006, Ciba Specialty Chemicals, Basle) or tetra-ethyl-2,2′-(1.4-phenylene-dimethylidene)-bismalonate (Hostavin @B-Cap, Clariant AG).

Mixtures of these ultraviolet absorbers may also be used.

0.0 wt % to 20.00 wt %, preferably from 0.05 wt % to 10.00 wt %, more preferably from 0.10 wt % to 1.00 wt %, even more preferably 0.10 wt % to 0.50% wt % and most preferably 0.10 wt % to 0.30 wt % of at least one or more UV absorbers are utilised, in relation to the total composition of the transparent, thermoplastic material.

### d) IR Absorbers

Suitable IR absorbers are, for example, disclosed in EP 1 559 743 A1, EP 1 865 027 A1, DE 10022037 A1 and DE 10006208 A1, as well as in the Italian patent applications RM2010A000225, RM2010A000227 and RM2010A000228. Quite particularly preferred are borides based on lanthanum hexaboride (LaB₆,) or mixtures containing lanthanum hexaboride.

Furthermore, IR-absorbing additives from the group of tungstates, which have a lower self-absorption in the visible spectrum compared to boride-based inorganic IR absorbers, and lead to thermoplastic materials with lower intrinsic colour, are suitable. In addition, they possess a desirably broad absorption characteristic in the NIR range. These tungstates concern tungsten oxides based on WyOz (W=tungsten, O=oxygen; z/y=2.20 to 2.99) or based on MxWyOz (M=H, He, alkali metal, alkaline earth metal, rare earths, Mg, Zr, Cr, Mn, Fe, Ru, Co, Rh, Ir, Ni, Pd, Pt, Cu, Ag, Au, Zn, Cd, Al, Ga, In, TI, Si, Ge, Sn, Pb, Sb, B, F, P, S, Se, Br, Te, Ti, Nb, V, Mo, Ta, Re, Be, Hf, Os, Bi; x/y=0.001 to 1, z/y=2.2-3.0).

The manufacture and use of these substances in thermoplastic materials is essentially well known, and described, for example, in H. Takeda, K. Adachi, J. Am. Ceram. Soc. 90, 4059-4061, (2007), WO 2005037932, JP 2006219662, JP 2008024902, JP 2008150548, WO 2009/059901 and JP 2008214596.

The IR absorbers are preferably used in an amount of 0.00150 wt % to 0.01500 wt %, preferably from 0.00180 wt % to 0.01100 wt %, and particularly preferably 0.00200 wt % to 0.00900 wt %, calculated used as solid matter in IR absorbers in the polymer composition as a whole.

### e) Colourants:

Inorganic nanoscale pigments, preferably carbon black, are optionally utilised as colourants. The nanoscale carbon black is preferably utilised in the composition in accordance with the invention in concentrations of 0.00000 wt % to 0.01 wt %.

Particularly preferred colourants, and colouring agent combinations for the base layer C are described in US 20120157587.

### f) Further Additives

Further additives, such as the polymer additives described in EP-A0 839 623, WO-A 96/15102, EP-A 0 500 496 or “Plastics Additives Handbook”, Hans Zweifel, 5th edition 2000, pub. Hanser Verlag, Munich (aforementioned exception).

In a particularly preferred embodiment of the present invention, the thermoplastic polymer for the carrier of the vehicle component is a polycarbonate having a molecular weight M_{w} from 22,000 to 35,000, more preferably 24,000 to 31,000 and particularly preferably 25,000 to 30,000, determined by gel permeation chromatography with polycarbonate calibration.

In a particularly preferred embodiment, a linear polycarbonate based on bisphenol A with MVR 5-20, preferably 6-18, particularly preferably 8-16, and most preferably 10-15 cm³/10 min at 300° C. and 1.2 kg load according to ISO 1133, comprising phenol and/or tert.-butylphenol and/or cumyl phenol as the chain terminator is particularly preferred.

The flowability of the polycarbonate used for the preparation of the base layer is, furthermore, sufficient to implement flow paths of 600 mm to 1200 mm, preferably 800 mm to 1100 mm, particularly preferably 900 mm to 1000 mm, in the injection compression moulding process, wherein the melt temperature is preferably between 280° C. and 320° C., more preferably between 300° C. and 310° C., the mould temperature is preferably between 60° C. and 110° C., more preferably between 80° C. and 100° C., the filling pressure between 50 bar and 1000 bar, more preferably between 80 bar and 750 bar, and most preferably between 100 bar and 500 bar, and the embossing gap between 0.5 mm and 10 mm, preferably between 2 mm and 7 mm, particularly preferably between 5 mm and 6 mm. A screen print is optionally to be found between B and A (on parts of the disc, for the non-transparent area or heating/antennae) or a 2K injection moulding component.

The base layer C is, in the context of the present invention, either a single layer or is produced by lamination, co-extrusion or injection back-moulding of two or more layers. Preferred is a single-layer structure of base layer C.

The transparent base layer C possesses layer thicknesses in the range of 1 mm-20 mm, preferably 1 mm-18 mm. For the following fields of application the layer thicknesses below in accordance with the invention apply.

Aeroplane: 16 mm, consisting of 2 layers, laminated

### Windscreen: 3-10/4-8/5-8 mm

Panoramic sunroof: 3-10/4-8/4-6 mm
Diffusion disc: 1-5/1-3 mm
Side window: 1-10/1-8/2-6 mm

### Layer D (Transparent UV Protection Layer)

Layer D is a primer layer, which is preferably based on a poly(alkyl) acrylate, particularly preferably PMMA, containing at least one UV absorber, preferably selected from the group comprising benzophenones, resorcinols and triazines. Particularly preferred triazines are, within the scope of the present invention, the 2-[2-hydroxy-4-(2-ethylhexyl) oxy]phenyl-4,6-di(4-phenyl) phenyl-1,3,5-triazine (CAS No. 204583-39-1), as well as the 2-[2-hydroxy-4-[(octyloxycarbonyl) ethylidenoxy]phenyl-4,6-di(4-phenyl) phenyl-1,3,5-triazine (CAS No. 204848-45-3). Particularly preferred benzophenones include, within the scope of the present invention, the 2,4-dihydroxybenzophenone, and generally 2-hydroxy-4-alkoxybenzophenones. Particularly preferred resorcinols are generally 4,6-dibenzoylresorcinols (i.e. 4,6-dibenzoylresorcinols, as well as substituted 4,6-dibenzoylresorcinols).

Preferred is a primer composition as described for Layer A in paragraph ii), comprising:

a) 100,000 parts by weight of a binder;
b) 0 to 900,000 parts by weight of one or more solvents;
c) 1 to 6,000, preferably 2,000 to 5,000, parts by weight of a formula (III) compound, as defined above;
d) 0 to 5,000 parts by weight of further light-stabilising substances.

The thickness of the Layer D is in the range of 1.0-6.0, preferably in the range from 1.2 to 5.0 μm, very particularly preferably in the range from 1.2-4.0 μm.

Alternatively, the layer D may be formed of a composite film comprising a film substrate and a second film layer applied thereto. In this respect, the film carrier preferably consists of polycarbonate or PMMA. A particularly preferred material for the film carrier is polycarbonate, particularly when functional elements, such as antennae or heating elements, are supposed to be applied to the film carrier. The second film layer may be a functional layer, such as a protective UV layer. The second film layer is, in this case, preferably made of polycarbonate or PMMA. In the context of a specific embodiment of the present invention, the second film layer is based on PMMA and contains a UV absorber of the type of the triazines, particularly preferably 2-[2-hydroxy-4-[(octyloxycarbonyl) ethylidenoxy]phenyl-4,6-di(4 phenyl) phenyl-1,3,5-triazine (CAS No. 204848-45-3). The composite film is preferably orientated in the multi-layer structure in accordance with the invention in such a way that the carrier film lies directly on the layer C of the multi-layer structure and the second film layer is orientated in the direction of Layer E.

Also on the second film layer of the film composite, additional functional elements can be applied, for example IR-reflecting foils or sputter coats (3M system/Southwall), heating elements, antenna elements or screen printing, as described above. Reflective coatings for IR and UV radiation count (IR radiation from 750 nm to 2,500 nm, UV radiation from 180 nm to 400 nm).

FIG. 2 visualises a possible structure with layers of film as Layer D.

The composite film (Layer D) is applied to Layer C of the multi-layer structure by injection back-moulding or lamination.

### Layer E:

The transparent wear-resistant layer E may, within the scope of the present invention, be based a siloxane network, which is preferably equipped with at least one UV absorber. In this respect, resorcinols, benzophenones, benzotriazoles, and triazines are preferred as UV absorbers, particularly preferred are resorcinols. Particularly preferred are formula IV resorcinols; quite particularly preferably are formula V resorcinols.

The UV absorber is used in amounts of between 5 and 12 wt %, preferably between 7 and 10 wt %.

The thickness of the transparent wear-resistant layer E is in the range of 3 μm to 25 μm, with the bulk of the layer thickness in the viewing area being 4 μm to 15 μm.

Alternatively, Layer E may exclusively consist of a silica layer having a layer thickness that falls within the range of 1 μm to 5 μm, preferably 2 μm to 4 μm, manufactured using plasma deposition or various sputtering methods, such as RF sputtering, magnetron sputtering, ion beam sputtering, etc., ion plating using the TLC, RF and HCD methods, reactive ion plating, etc., or chemical vapour deposition.

In a further embodiment, the silica layer may be applied to a layer as described above, based on a siloxane network.

The silica layer may contain UV absorbers (organic and/or inorganic).

In a specific embodiment, the base layer C and any further layers directly or indirectly connected with it together with additional integrated functional elements form the multi-layer structure in accordance with the invention.

In this respect, the following additional function elements may be integrally moulded and/or integrated into the multi-layer structure in accordance with the invention:
Heating elements
Antennae
A lamp housing/lamp holder, e.g. for taillights, direction indicators, brake lights, number plate lighting and high-mounted brake lights.
Windscreen wipers and windscreen wiper (motor) receptacle
Styling lines
Structural elements for water management (drainage of spray water and rainwater)
Solar modules

In a specific embodiment, a further chromophoric layer containing colourants and/or pigments or and or a heat-absorbing or heat-reflecting layer may be included in the multi-layer structure between one or more of the layers A, B, C, D and E. In this respect, this layer is preferably based on polycarbonate or PMMA, particularly preferably polycarbonate. The additional chromophoric layer is preferably located between Layers B and C or between Layers C and D.

The additional heat-absorbing or heat-reflecting layer is preferably located between Layers C and D. The additional layers or films may be applied partially over the whole area or partially or at certain points on the area.

A method of manufacturing the multi-layer structure in accordance with the invention:

The multi-layer structure in accordance with the invention can be manufactured in accordance with usual methods. These methods include (co-)extrusion, direct skinning, direct coating, insert moulding, film injection back-moulding, flow coating, dip coating, spray coating or plasma coating, roller coating, spin coating or other suitable methods known to the specialist.

Injection moulding processes are known to the specialist, and described, for example, in “Handbuch Spritzgieβen” [“Injection Moulding Manual” ], Friedrich Johannaber/Walter Michaeli, Munich; Vienna: Hanser, 2001, ISBN 3-446-15632-1 or “Anleitung zum Bau von Spritzgieβwerkzeugen” [“Instructions for Constructing Injection Moulding Tools” ], Menges/Michaeli/Moors, Munich; Vienna: Hanser, 1999, ISBN 3-446-21258-2.

Extrusion processes are known to the specialist, and described, for example for co-extrusion, inter alia in EP-A 0 110 221, EP-A 0 110 238 and EP-A 0 716 919. For details of the adapter and jet method, see Johannaber/Ast: “Kunststoff-Maschinenführer” [“Plastics Machine Operator” ], Hanser Verlag, 2000 and in Plastics Technology Association: “Coextrudierte Folien und Platten: Zukunftsperspektiven, Anforderungen, Anlagen und Hferstellung, Qualitätssicherung” [“Co-extruded films and plates: future prospects, requirements, systems and manufacture, quality assurance” ], pub. VDI Verlag, 1990.

The manufacture can be carried out in the following ways:

### Procedure 1:

Inserting the film (Layer D) into the injection mould, —closing the mould
Injecting polycarbonate (Layer C), with subsequent cooling to <145° C., component temperature (more preferably <130° C., particularly preferably <120° C.), but not below 80° C.
Rotating the cavity to the next position, for the purpose of injecting a blend component (Layer B). A gap emerges between the 1st solidified material component and the mould wall cavity when closing the mould in this position.
Injecting the blend component, subsequent cooling to <145° C., component temperature (more preferably <130° C., particularly preferably <120° C.), but not below 80° C.

In an alternative embodiment of Procedure 1, the film can also be dispensed with during manufacture.

Procedure 2: Coating Following Procedure 1 (with or without Film)
De-moulding
Cooling down the component to room temperature
Flow coating the component with the primer
Evaporating the solvent (preferably for at least 30 mins)
Burning in/drying the primer at 20° C. to 200° C., preferably 40° C. to 130° C. (preferably for 45 mins at 130° C.).
Cooling down to room temperature
Coating with top coat
Evaporating the solvent (preferably for at least 30 mins)
Burning in/drying the top coat E at 20° C. to 200° C., preferably 40° C. to 130° C. (preferably, for 45 mins at 130° C.)
Cooling down to room temperature

### EXAMPLES

The materials used are characterised as follows:

Polycarbonate: Linear bisphenol A polycarbonate with end groups based on phenol with an MVR of 12.5 cm³/10 mins, measured at 300° C. and 1.2 kg load according to ISO 103. This polycarbonate still contains an additive mixture consisting of release agents, thermostabilisers and UV stabilisers. 0.27 wt % pentaerythritol tetrastearate (CAS 115-83-3) is used as a release agent, 0.25 wt % triphenylphosphine (CAS 603-35-0) as a thermostabiliser, and 0.20 wt % Tinuvin® 329 (CAS 3147-75-9) as a mould UV stabiliser.

Blend: Polycarbonate/ABS blend containing 82% polycarbonate based on bisphenol A and 9% ABS prepared in accordance with the bulk process, with 9% talc filling and a melt volume flow rate (MVR) in accordance with ISO 1133 of 18 cm³/10 mins, measured at 260° C. and a load of 5 kg. In addition, 0.5% PETS-based release agents are contained in it, and 0.2% thermostabilisers. The product is an opaque material dyed with deep carbon black.

The AS4700 scratch-resistant coating is a thermally-cured varnish based on silicone containing isopropyl alcohol, n-butanol and methyl alcohol as solvents, with a solids content of 25 wt %, a specific gravity of 0.92 g/cm³ at 20° C., and a viscosity measured at 25° C. of 3-7 MPa s. The product is available from Momentive Performance Materials GmbH, Leverkusen.

SHP470 FT 2050 is a primer with a solids content of 9 wt % of a specific gravity of 0.94-0.96 g/cm³ at 20° C. and a viscosity at 25° C. of 75 to 95 MPa s based on 1-methoxy-2-propanol as the solvent. The product is available from Momentive Performance Materials GmbH, Leverkusen.

The AS4000 scratch-resistant coating is a silicone-based thermally-cured varnish, containing methyl alcohol, n-butanol and isopropyl alcohol as solvents, with a solids content of 19-21 wt %, a specific gravity of 0.91 g/cm³ at 20° C., and a viscosity measured at 25° C. of 4-7 MPa s. The product is available from Momentive Performance Materials GmbH, Leverkusen.

SHP401 is a primer with a solids content of 2 wt %, a specific gravity of 0.925 g/cm³ at 20° C., and a viscosity at 25° C. of 4-7 MPa s, based on 1-methoxy-2-propanol and diacetone alcohol as solvents.

The product is available from Momentive Performance Materials GmbH, Leverkusen.

Multi-layer composites are produced in the following way:
a) Injecting polycarbonate (Layer C) into a suitable mould, with subsequent cooling to <145° C. component temperature (more preferably <130° C., particularly preferably <120° C.), but not below 80° C.
b) Rotate the cavity to the next position, for the purpose of injecting a blend component (Layer B). A gap emerges between the 1st solidified material component and the mould wall cavity when closing the mould in this position.
c) Injecting the blend component, subsequent cooling to <145° C., component temperature (more preferably <130° C., particularly preferably <120° C.), but not below 80° C.
d) Demoulding
e) Cooling down of the component to room temperature
f) Flow coating the component with the primer
g) Evaporating the solvent (preferably for at least 30 mins)
h) Burning in/drying the primer at 20° C. to 200° C., preferably 40° C. to 130° C. (preferably for 45 mins at 130° C.).
i) Cooling down to room temperature
j) Coating with top coat
k) Evaporating the solvent (preferably for at least 30 mins)
l) Burning in/drying the top coat E at 20° C. to 200° C., preferably 40° C. to 130° C. (preferably for 45 mins at 130° C.)
m) Cooling down to room temperature

### Measuring the Resistance to Weathering

The accelerated weathering is carried out in accordance with ASTM G155mod in a Ci 65 A atlas. The intensity is 0.75 W/m/m² at 340 nm wavelength and a drying/spraying cycle is 102:18 minutes. The black panel temperature is 70±3° C., and the atmospheric humidity during the drying cycle is 40±3%. Inner and outer filter are boro filters.

The weathering is terminated as soon as cracks or micro-cracks occur and/or delaminations can be seen. Structures in accordance with the invention show the first flaws at the earliest after 5500 hours' accelerated weathering.

I. Comparison of Different Layer Thicknesses when Using the AS4700 Coating System with SHP470FT 2050 for the Structure.

The following examples demonstrate that there is a necessary minimum layer thickness for the primer and top coat, as otherwise it will deteriorate prematurely when weathering.

A multi-layer structure consisting of:

### Example 1

### In Accordance with the Invention

A) SHP470 FT2050, layer thickness approx. 1.2 μm+AS4700, layer thickness approx. 6.2 μm
B) Blend components, layer thickness 1.9 mm
C) Polycarbonate, layer thickness 4.8 mm,
wherein B) is injection back-moulded with C).
D) SHP470 FT2050, layer thickness 1.2 μm
E) AS4700, layer thickness 6.2 μm

### Example 2

### In Accordance with the Invention

A) SHP470 FT2050, layer thickness approx. 1.9 μm+AS4700, layer thickness approx 8.6 μm
B) Blend components, layer thickness 1.9 mm
C) Polycarbonate, layer thickness 4.8 mm
wherein B) is injection back-moulded with C).
D) SHP470 FT2050, layer thickness 1.9 μm
E) AS4700, layer thickness 8.6 μm

### Example 3

### In Accordance with the Invention

A) SHP470 FT2050, layer thickness approx. 2.3 μm+AS4700, layer thickness approx 9.5 μm
B) Blend components, layer thickness 1.9 mm
C) Polycarbonate, layer thickness 4.8 mm,
wherein B) is injection back-moulded with C).
D) SHP470 FT2050, layer thickness 2.3 μm
E) AS4700, layer thickness 9.5 μm

### Example 4

### Comparison

A) SHP470 FT2050, layer thickness approx. 0.8 μm+AS4700, layer thickness approx. 4.3 μm
B) Blend components, layer thickness 1.9 mm
C) Polycarbonate, layer thickness 4.8 mm
wherein B) is injection back-moulded with C).
D) SHP470 FT2050, layer thickness 0.8 μm
E) AS4700, layer thickness 4.3 μm

The results are summarised in Table 1 below:

| | The weathering time | A change in the lustre, Δ lustre/gloss units | | | | | |
|---|---|---|---|---|---|---|---|
| | until the first cracks, | After | After | After | After | After | After |
| | micro-cracks and/or | 1,000 | 2,000 | 3,000 | 4,000 | 5,000 | 6,000 |
| | delaminations appear | hours | hours | hours | hours | hours | hours |
| Example 1 | 5,500 hours | −2.0 | −2.9 | −1.4 | −3.5 | −3.8 | −5.4 |
| (in accordance with the | | | | | | (4437 hrs.) | (5441 hrs.) |
| invention) | | | | | | | |
| Example 2 | 5,500 hours | 1.9 | 2.1 | 1.8 | | −0.3 | −1.2 |
| (in accordance with the | | | | | | (4437 hrs.) | (5441 hrs.) |
| invention) | | | | | | | |
| Example 3 | 6,000 hours | −2.1 | −1.3 | −1.4 | −4.4 | −4.6 | −4.0 |
| (in accordance with the | | | | | | (4437 hrs.) | |
| invention) | | | | | | | |
| Example 4 | 3,000 hours | 1.2 | 0 | 0 | −3.7 | | |
| (comparison) | | | | | | | |

Table 1 shows that Examples 1 to 3 in accordance with the invention have a noticeably better reaction in regard to crack formation and delamination in the case of weathering, and better gloss behaviour than the comparative Example 4. This demonstrates that there is a necessary minimum thickness for the primer and top coat, as otherwise they will deteriorate prematurely when weathering. Comparative examples 5 and 6 show the same construction. They are distinguished from the examples in accordance with the invention by the fact that Layers A and B are missing, wherein Example 6 is simulated by placing a black plate behind the non-transparent layer. The deposition of a black plate is necessary, since, in the case of a non-transparent layer firmly connected to the remainder of the layer structure, the transmission and turbidity values cannot be measured. Therefore, Example 9 is provided with a black Makrolon panel during the weathering. The black plate is removed for measuring.

### Example 5

### Comparison

A) No varnishing
B) No non-transparent components
C) Polycarbonate, layer thickness 3.2 mm
D) PMMA+10%+2% CGL479+2% Tinuvin 622, layer thickness 2.7 μm
E) AS4700, layer thickness 5.8 μm

Weathered in Xe-WOM, cracks occur at 8,000 hrs.

### Example 6

### Comparison, as Example 5, but with a Black Background when Weathering

A) No varnishing
B) Black plastic panel, layer thickness 3.2 mm, which is fixed behind Layer C with clamps.
C) Polycarbonate, layer thickness 3.2 mm
D) PMMA+10%+2% CGL479+2% Tinuvin 622, layer thickness 2.9 μm
E) AS4700, layer thickness 5.7 m
   Weathered in Xe-WOM, cracks occur at 6,000 hours

The results are summarised in Table 2 below:

| Weathering | Yellowness index | | Turbidity/haze/% | |
|---|---|---|---|---|
| time in hours | Example 5 | Example 6 | Example 5 | Example 6 |
| 0 | 1.21 | 1.13 | 0.2 | 0.2 |
| 1,000 | 0.88 | 0.98 | 0.8 | 0.9 |
| 1,979 | 1.33 | 1.44 | 1.1 | 1.1 |
| 3,020 | 1.62 | 1.77 | 1.2 | 1.5 |
| 4,000 | 2.03 | 2.10 | 1.3 | 1.5 |
| 5,021 | 2.49 | 2.37 | 1.3 | 1.5 |
| 6,010 | 3.48 | 2.94 | 1.93 | 1.81 |
| 6,990 | 4.71 | | 2.7 | |
| 8,000 | 6.36 | | 4.00 | |

Examples 5 and 6 show that samples having a black background or that are injection back-moulded more rapidly give rise to cracks than is the case with transparent samples, during weathering, when the structure is otherwise identical.

It can be seen from these results that multi-layer systems with non-transparent layers exhibit poor weathering resistance. Layer thicknesses which exhibit good weathering when constructed transparently are not suitable for systems (multi-layer structures) with non-transparent layers. Therefore, the task was to provide a system that would ensure that, even with a non-transparent layer, a good property profile would be achieved in regard to weathering resistance, surface quality (optical properties), a higher scratch resistance, resistance to chemicals, and also lifespan and adhesion.

### Comparison of SHP470 FT 2050 and SHP470 Primer in the Case of Black Background Plates:

### Example 7

### With Black Background!

A) No varnishing
B) Plastic panel dyed black, thickness 3.2 mm
C) Polycarbonate, layer thickness 3.2 mm, wherein layer C) is injection back-moulded with layer B).
D) SHP470 FT 2050, layer thickness 1.8 μm
E) AS4700, layer thickness 4.7 μm
Weathered in Xe-WOM, cracks occur at 7.500 hours

### Example 8

### With Black Background!

A) No varnishing
B) Plastic panel dyed black, thickness 3.2 mm
C) Polycarbonate, layer thickness 3.2 mm, wherein layer C) is injection back-moulded with layer B).
D) SHP470, layer thickness 1.8 μm
E) AS4700, layer thickness 6.5 μm
   Weathered in Xe-WOM, cracks occur at 00 hours

The results are summarised in Table 3 below:

| Weathering | Yellowness index | | Turbidity/haze/% | |
|---|---|---|---|---|
| time in hours | Example 7 | Example 8 | Example 7 | Example 8 |
| 0 | −8.75 | −9.66 | 0.8 | 0.6 |
| 1,000 | −8.55 | −9.30 | 1.6 | 0.9 |
| 1,985 | −6.56 | −6.85 | 1.8 | 1.1 |
| 2,500 | −5.69 | −5.89 | 2.2 | 1.2 |
| 3,000 | −4.98 | −4.85 | 2.2 | 1.4 |
| 3,500 | −4.29 | −3.69 | 2.4 | 1.4 |
| 4,000 | −3.54 | −2.55 | 2.6 | 1.5 |
| 4,494 | −2.39 | −1.21 | 2.9 | 1.8 |
| 4,986 | −1.70 | 0.49 | 3.1 | 2.0 |
| 5,500 | −0.65 | 4.35 | 3.3 | 2.1 |
| 5973 | 0.08 | | 3.5 | |
| 6500 | 1.60 | | 3.7 | |
| 6992 | 3.16 | | 3.9 | |
| 7505 | 4.86 | | 4.33 | |

Conclusion: The SHP470 primer is not as powerful as the SHP 470 FT 2050 primer in the case of samples with a black background.

### Investigation of Adhesion of UV-Cured Protective Layer to the PC Substrate:

The following adhesion tests were carried out:

(a) Adhesive tape pull-off (adhesive tape used: 3M Scotch 898) with cross-cut (along the lines of ISO 2409 or ASTM D 3359); and
(b) Adhesive tape pull-off after 1, 2, 3 and 4 hours' storage in boiling water (along the lines of ISO 2812-2 and ASTM 870-02).

All the examples noted here showed full adhesion, after both (a) and (b) (ISO parameter: 0 or ASTM parameter: SB).

### Measurement of the Abrasion Resistance and Determination of the Taber Value:

First of all the initial haze value of the PC panel coated with the UV-cured first layer (received from c) was determined in accordance with ASTM D 1003 using a Haze Gard Plus from the company Byk Gardner. The coated side of the sample was subsequently scratched using a Taber abraser, Type 5131, from the company Erichsen in accordance with ISO 52347 or ASTM D 1044, using the CS10F wheels (Type IV; a grey colour). By determining the end haze value after 1000 revolutions with 500 g applied weight, a Δ haze value (sample) could be determined.

Within the meaning of the invention, the protective layer should have a sufficiently high degree of scratch-resistance. This criterion has been achieved, for the purposes of the invention, in the case of an increase in turbidity of less than 4% after 100 cycles of the Taber test (conducted in accordance with UN ECE Regulation 43, Appendix 3, paragraph 4) for the inner layer A or an increase in turbidity of less than 10% after 500 cycles for the outer layer E.

### Measurement of the Resistance to Various Solvents

The samples were stored horizontally on a laboratory bench at room temperature (e.g. 23° C.). A cotton wool swab soaked in acetone was placed on the sample and covered with a watch glass to prevent evaporation of the solvent. After various exposure times (1 min, 5 mins, 15 mins, 30 mins), the watch glass and the cotton ball swab were removed. The surface of the sample was gently dried with a soft cloth. The surface was evaluated visually. In the event of any visible damage, the result is noted as “OK”; should there be any visible damage, the result is designated “not OK”. For the purposes of the invention, the protective layer should have a sufficiently high resistance to xylol, butyl acetate, isopropyl alcohol, acetone, and iso-octane. This criterion has been achieved within the meaning of the invention, if, after 1 hour, no visible damage is present (and the result is accordingly designated “OK”).

### Measuring the Resistance to Petroleum Spirit

The chemical resistance to petrol under load is determined in accordance with UN ECE Regulation 43, Appendix 3, paragraph 11. For this, the test sample is clamped as a horizontal lever arm. At the free end of the sample, at a distance of 102 mm from the support point, a load is to be applied, so that a force of about 6.9 MPa is exerted. While the test specimen is loaded, the petroleum spirit (consisting of 50 vol % toluene, 30 vol % 2,2,4-trimethylpentane, 15 vol % 2,2,4-trimethyl-1-pentene and 5 vol % ethanol) is applied with a soft brush to the surface of the test sample. The brush is stroked ten times over the test sample, and spread over the specimen and moistened before each stroke. The test has been passed if no cracks or obvious loss of transparency can be discerned.

### Measuring the Pencil Hardness

The pencil hardness was measure along the lines of ISO 15184 or ASTM D 3363.

By way of preparation, the pencil was drawn across sandpaper (No. 400) at an angle of 90°, to obtain a sharp-edged flat surface. The sample to be measured needs to be placed on an even, horizontal substrate. The pencil was clamped in a sliding carriage with 0.75 kg (+/−10 g) applied weight, and the latter was placed on the surface to be tested and immediately pushed at least 7 mm above the surface. Using a damp cloth (possibly use isopropyl alcohol), the markings of the marks the graphite pencil were removed from the surface, and the latter inspected for any damage.

The hardness of the hardest pencil which did not damage the surface is what is known as the pencil hardness:

Hardness Scale in Accordance with ISO 15184 (1998 E), from Soft to Hard:

### 9B-8B-7B-6B-5B-4B-3B-2B-B-HB-F-H-2H-3H-4H-5H-6H-7H-8H-9H

Selecting the Coating Systems Based on their Chemical Resistance and Abrasion Resistance

Coating systems in accordance with the invention are distinguished by low initial turbidity (<1% haze), good chemical resistance to xylene, butyl acetate, isopropyl alcohol, acetone and iso-octane (resistant, i.e. no visible damage, cracks, turbidity or delamination for at least 30 minutes' exposure time at room temperature), good adhesion (parameter 0 after pulling off the adhesive tape, even after a 4-hour boiling test), as well as good abrasion resistance (increase in turbidity of less than 4% after 100 cycles of the Taber test (conducted in accordance with UN ECE Regulation 43, Appendix 3, paragraph 4) for the inner layer A or an increase in turbidity of less than 10% after 500 cycles for the outer layer E.)

The corresponding measurement results are displayed in the following table.

The chemical resistance to petrol under load in accordance with UN ECE Regulation 43, Appendix 3, paragraph 11 needs to be given.

Particularly well suited, therefore, are scratch-resistant coatings based on siloxane, such as the AS4700 and AS4000 coatings of the company Momentive Performance Materials.

| | Coating | | | | |
|---|---|---|---|---|---|
| | AS 4700 with | | | | |
| | SHP470 FT 2050 | AS 4000 with | | | |
| | primer | SHP 401 primer | PHC 587 C | UVHC 3000 | UVT 610 |
| | (Momentive) | (Momentive) | (Momentive) | (Momentive) | (RedSpot) |
| Layer thickness/μm | Primer: 2.1-2.7 | 7.3-7.6 | 7.63-7.80 | 8.7-9.6 | 5.3-6.9 |
| | Top coat 4.7-5.5 | | | | |

Optical properties

| | | | | | |
|---|---|---|---|---|---|
| Yellowness index of | 1.49 | 1.34 | 1.01 | 0.95 | 1.49 (on AL2647) |
| the coating on M3103 | | | | | |
| Initial turbidity/% on | 0.55 | 0.25 | 0.43 | 0.63 | 0.49 (on AL2647) |
| M3103 | | | | | |

Resistance to chemical agents

| | | | | | |
|---|---|---|---|---|---|
| Xylene | 1 hr. OK | 1 hr. OK | 1 hr. OK | 1 hr. OK | 1 hr. OK |
| Butyl acetate | 1 hr. OK. | 1 hr. OK | 1 hr. OK | 1 hr. OK | 1 hr. OK |
| Isopropyl alcohol | 1 hr. OK | 1 hr. OK | 1 hr. OK | 1 hr. OK | 1 hr. OK |
| Acetone | 1 hr. OK | 1 hr. OK | 1 hr. OK | 1 hr. OK | 1 hr. OK |
| Isooctane | <1 hr. | 1 hr. OK | 1 hr. OK | 1 hr. OK | 1 hr. OK |

Chemical resistance under load in accordance with UN ECE R43, Appendix 3,
paragraph 11, petroleum spirit consisting of 50 vol % toluene, 30 Vol %
2,2,4-trimethylpentane, 15 vol % 2,2,4-trimethyl-1-pentene and 5 vol % ethanol.

| | | | | | |
|---|---|---|---|---|---|
| Petroleum spirit | No objection | No objection | No objection | No objection | No objection |

Resistance to abrasion and scratch-resistance

| | | | | | |
|---|---|---|---|---|---|
| Taber/Δ haze 100 | 0.58 | 1.22 | 2.29 | 2.17 | 12.1 |
| cycles | | | | | |
| Taber/Δ haze 1,000 | 2.22 | 4.33 | 6.45 | 5.94 | 30.6 |
| cycles | | | | | |
| Pencil hardness | 2H | H | H | 2H | F |

Adhesion to polycarbonate after cross-cut and the adhesive tape being pulled
off after 4 hours' storage in 100° C. hot water, assessment in
accordance with ISO 2812-2, ISO parameter = 0 means full adhesion).

| | | | | | |
|---|---|---|---|---|---|
| Adhesion | 0 | 0 | 0 | 0 | 0 |

1.-16. (canceled)

17. A multi-layer structure comprising the following layers:
a) a transparent Layer A with a layer thickness of 3 μm to 20 μm;
b) a non-transparent Layer B with a layer thickness of 1 mm to 20 mm;
c) a transparent Layer C with a layer thickness of 1 mm to 20 mm;
d) a transparent Layer D as a protective UV layer with a layer thickness of 1 μm to 6 μm;
e) a transparent Layer E with a layer thickness of 3 μm to 25 μm.

18. The multi-layer structure in accordance with claim 17, wherein Layer A has a layer thickness of 5 μm to 15 μm, Layer B and Layer C each have a layer thickness of 1 mm to 18 mm, Layer D has a layer thickness of 1.2 μm to 5 μm and Layer E a layer thickness of 4 μm to 15 μm.

19. The multi-layer structure in accordance with claim 17, wherein Layer A has a layer thickness of 6 μm to 12 μm.

20. The multi-layer structure in accordance with claim 17, wherein Layer A has a layer thickness of 6 μm to 12 μm and Layer E a layer thickness of 4 μm to 15 μm.

21. The multi-layer structure in accordance with claim 17, wherein Layer A and Layer E comprise a polysiloxane varnish, and wherein a primer coating may be applied between Layer B and the polysiloxane varnish of Layer A.

22. The multi-layer structure in accordance with claim 21, wherein Layer A or Layer E or Layers A and E contain a UV absorber.

23. The multi-layer structure in accordance with claim 22, wherein the UV absorber is selected from at least one taken from the group of benzophenones and resorcinols.

24. The multi-layer structure in accordance with claim 17, wherein Layer B is made of a polymer blend.

25. The multi-layer structure in accordance with claim 24, wherein the polymer blend comprises a polycarbonate and a polyester.

26. The multi-layer structure in accordance with claim 17, wherein Layer C is a thermoplastic polymer.

27. The multi-layer structure in accordance with claim 26, wherein the thermoplastic polymer is selected from the group consisting of polycarbonate, copolycarbonate, polyester carbonate, polystyrene, styrene copolymers, aromatic polyesters, PET-cyclohexane dimethanol copolymer (PETG), polyethylene naphthalate (PEN), polybutylene terephthalate (PBT), polyamide, cyclic polyolefin, poly- or copolyacrylates, poly- or copoly methacrylate, thermoplastic polyurethanes, polymers based on cyclic olefins, and mixtures thereof.

28. The multi-layer structure in accordance with claim 26, wherein Layer C contains a UV absorber or IR absorber or a mixture of UV and IR absorbers.

29. The multi-layer structure in accordance with claim 17, wherein Layer D is a primer layer.

30. The multi-layer structure in accordance with claim 17, wherein the primer layer is based on poly(alkyl) acrylate, which contains at least one UV absorber selected from the group consisting of benzophenones, resorcinols and triazines.

31. The multi-layer structure in accordance with claim 17, further comprising a functional element for water management.

32. The multi-layer structure in accordance with claim 17, wherein;
Layer A is a polysiloxane layer with a primer layer based on poly(alkyl) acrylate, and a UV absorber from the structural class of the benzophenones, resorcinols or triazines;
Layer B is a polymer blend with a composition comprising the polymers a1 to a3, wherein
a1) is 10 to 100 parts by weight, preferably 60 to 95 parts by weight, particularly preferably 75 to 95 parts by weight, in particular 85 to 95 parts by weight (based on the sum of components A) and B)) of at least one component selected from the group consisting of aromatic polycarbonate, aromatic polyester carbonate, polymethyl methacrylate (co) polymer and polystyrene (co) polymer, and
a2) is 0 to 90 parts by weight, preferably 5 to 40 parts by weight, especially preferably 5 to 25 parts by weight, in particular 5 to 15 parts by weight (in relation to the sum of the components A) and B)) of at least one graft copolymer,
a3) is optionally rubber-free vinylhomopolymerisate and/or rubber-free vinyl copolymerisate,
wherein said parts by weight of the components a1 to a3 add up to 100,
Layer C consists of polycarbonate, copolycarbonate or polyester carbonate, which may contain the UV absorber and/or IR absorber,
Layer D is a primer layer, and the primer is available after being cured from a composition of
a) 100,000 parts by weight of a binder;
b) 0 to 900,000 parts by weight of one or more solvents;
c) 1 to 6,000, preferably 2,000 to 5,000, parts by weight of a formula (III) compound;
d) 0 to 5,000 parts by weight of further light-stabilising substances 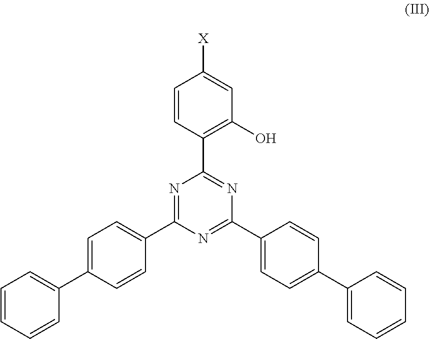
wherein X=OR⁶, OCH₂CH₂OR⁶, OCH₂CH(OH)CH₂OR⁶ or OCH(R⁷)COOR⁸, where
R⁶=branched or unbranched C₁-C₁₃-alkyl, C₂-C₂₀-alkenyl, C₆-C₁₂-aryl, or CO—C₁-C₁₅ alkyl,
R⁷=H or branched or unbranched C₁-C₈ alkyl; and
R⁸=C₁-C₁₂-alkyl; C₂-C₁₂-alkenyl or C₅-C₆ cycloalkyl,
Layer D is a foil compound made of polycarbonate or polymethyl methacrylate and a functional coating.
